(19) United States
(12) Patent Application Publication
(10) Pub. No.: US 2017/0116531 A1
(43) Pub. Date: Apr. 27, 2017

(54) DETECTING EMERGING LIFE EVENTS AND IDENTIFYING OPPORTUNITY AND RISK FROM BEHAVIOR

(71) Applicant: International Business Machines Corporation, Armonk, NY (US)

(72) Inventors: Chitra Dorai, Chappaqua, NY (US); Roger D. Lederman, Briarcliff Manor, NY (US); Ying Li, Mohegan Lake, NY (US)

(21) Appl. No.: 14/924,014

(22) Filed: Oct. 27, 2015

(51) Int. Cl. G06N 5/04; G06N 99/00

(52) U.S. Cl. CPC G06N 5/04; G06N 99/005

(57) ABSTRACT

A method, system and computer program product for detecting an emerging life event and identifying an action plan to remediate affects of the life event are disclosed. In an embodiment, the method comprises specifying a group of emerging life events, and a group of behavior features that map to the emerging life events; receiving behavioral data identifying behavior of a person; and analyzing the behavioral data to determine if any of the specified behavior features are identified in the behavioral data. When one or more of the behavior feature are identified in the behavioral data as behavior features of the person, the identified behavior features are mapped to one or more of the specified emerging life events; and the mapped emerging life events is used to determine an action plan to remediate affects of that life event.

### BACKGROUND

This invention generally relates to detecting emerging life events and identifying opportunities and risks associated with the detected life events.

There are many situations in which events that happen, or are about to happen, in people's lives have important effects on their behaviors and activities. These emerging events may create significant difficulties or opportunities, for both the person and for others. For example, a person's spouse loses a job, putting the family into a difficult financial situation, thereby causing them to default on their mortgage payment. This may result in difficulties for the borrower and for the financial institution which provided the mortgage, or other lender or mortgage servicer, that collected the money for the mortgage.

In the financial services field, for example, the traditional focus of mortgage servicers in identifying loans that are at risk of default is to use various analytical models for predicting the likelihood of borrowers defaulting on their loans. Such models rely heavily on the borrower's past delinquency history, bankruptcy/foreclosure initiation, loan-to-value ratio, interest rates and other factors to predict the default likelihood. However, under the right set of circumstances, even those borrowers that have a good credit history “on the books” may consider defaulting on their loans.

Early identification of such borrowers and a mechanism for offering such borrowers remedial strategies may be beneficial to the mortgage servicer or the lender, the borrower and to the government in order to stave off widespread defaults. Currently, many remedial strategies exist that are sponsored by the government or by lenders. Such remedial strategies generally involve modifying an existing loan that is at risk by, for example, an interest rate reduction and/or a principal write-down of the loan.

### SUMMARY

Embodiments of the invention provide a method, system and computer program product for detecting an emerging life event and identifying an action plan to remediate affects of the life event. In an embodiment, the method comprises specifying a group of defined emerging life events, and a group of defined behavior features that map to the defined emerging life events; receiving, by a data processing system, behavioral data identifying behavior of a person; and analyzing the behavioral data, by the data processing system, to determine if any of the specified group of defined behavior features are identified in the behavioral data as behavior features of said person. When one or more of the specified group of defined behavior feature are identified in the behavioral data as behavior features of said person, said one or more of the identified behavior features are mapped, by the data processing system, to one or more of the specified group of defined emerging life events; and the mapped one or more defined emerging life events is used to determine an action plan to remediate affects of the mapped one or more life events on a specified activity of the person.

In embodiments of the invention, the specifying a group of defined emerging life events, and a group of defined behavior features that map to the defined emerging life events includes inputting into the data processing system historical time-series of behavioral data of a group of people, the behavioral data including a multitude of behavior features and a multitude of life events associated with the multitude of behavior features, and building a model, by the data processing system, to learn associations between the multitude of behavior features and the multitude of life events. The mapping said one or more of the identified behavior features, by the data processing system, to one or more of the specified group of defined emerging life events includes using the model to map said one or more of the identified behavior features, by the data processing system, to one or more of the specified group of defined emerging life events

In embodiments of the invention, the specified group of behavior features are extracts of financial payments.

In embodiments of the invention, the extracts of financial payments include one or more of the following: mean amount of missed payment, average ratio of missed payment amount over total payment amount, ratio of missed payments over required payment, payment miss flag, average duration of payment delay, coefficient of variation of payment delay, and ratio of payment drifts across grace period.

In embodiments of the invention, the using the mapped one or more of the emerging life events to determine an action plan includes constructing a personalized model for predicting future behavior of the person based on a profile of the person and a selected one or more of the emerging life events.

In embodiments of the invention, the using the mapped one or more of the emerging life events to determine an action plan further includes determining actions to achieve a desired outcome from the predicted future behavior.

In embodiments of the invention, the action plan mitigates consequences of the predicted future behavior of the person.

In embodiments of the invention, the action plan is an action plan for the person.

In embodiments of the invention, the action plan is an action plan for an entity or an individual other than the person.

In embodiments of the invention, the action plan mitigates consequences of predicted future behavior of the person on said entity or individual.

Current approaches detect life events by mining text or speech. However, many important emerging life events are rarely disclosed explicitly, and if they are declared explicitly, it is after the fact—that is, after the event has occurred.

Embodiments of the invention detect emerging events in the lives of people by studying their temporal behaviors, such as payment behaviors, engagements, product searches, etc. For example, person A's monthly mortgage payment behavior has been changing in the past few months—running behind the payment schedule, paying less than he should pay, etc. These patterns allow for the detection of the emerging event in A's life that may be leading to this observed payment behaviors.

For example, an observed delay in payments may arise from a job loss and efforts to get another job not proving successful over time. This behavior can be detected, and from that, a conclusion can be inferred that a person has lost his or her job and is looking for another job. When the emerging life event is detected, appropriate action can be taken based on the event.

In embodiments of the invention, machine learning algorithms may be leveraged to additionally identify likely future behaviors of customers, for example.

Patterns that can be observed may be used to train a statistical model to detect the underlying life events with certain confidence. The fact that these life events exist emerges from the detection of the patterns.

Once the model is trained, the model can be used to predict potential, emerging events that may have occurred, or are occurring, to a new person.

When the event is detected, appropriate actions can be taken based on outcomes observed during or after past instances of the event in other peoples' lives.

Embodiments of the invention improve over the prior art in a number of ways. For example, embodiments of the invention improve over the prior art by allowing for detection of emerging events that are not necessarily pre-defined, and by studying patterns of behavior that may signal an event only implicitly. Embodiments of the invention also improve over the prior art by directly tying an event to an outcome of importance, e.g., future likelihood of payment, and by proposing appropriate actions to manage the event.

### BRIEF DESCRIPTION OF THE DRAWINGS

FIG. 1 is a pictorial representation of a network of data processing systems in which embodiments of the invention may be implemented.

FIG. 2 shows a block diagram of a data processing system that may be used in the network of FIG. 1.

FIG. 3 illustrates detecting life events by studying temporal behaviors, and using those detected life events to identify likely future behaviors.

FIG. 4 illustrates a statistical model trained to detect life events.

FIG. 5 includes a chart showing examples of payment behavior patterns.

FIG. 6 shows the mean amount of missed payments for two groups of loans.

FIG. 7 shows the average ratio of missed payment amount to total payment amount for two groups of loans.

FIG. 8 depicts the ratio of missed payments to required payment of two groups of loans.

FIG. 9 illustrates the average percentage of two groups of loans that have missed at least one payment.

FIG. 10 shows the average payment delays for two groups of loans.

FIG. 11 shows the coefficient of variation of payment delay for two groups of loans.

FIG. 12 illustrates the ratio of payment drifts across a grace period for two groups of loans.

FIG. 13 shows payment feature distribution analyses with respect to different personal hardships.

FIG. 14 shows a further payment feature distribution analysis with respect to different personal hardships.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

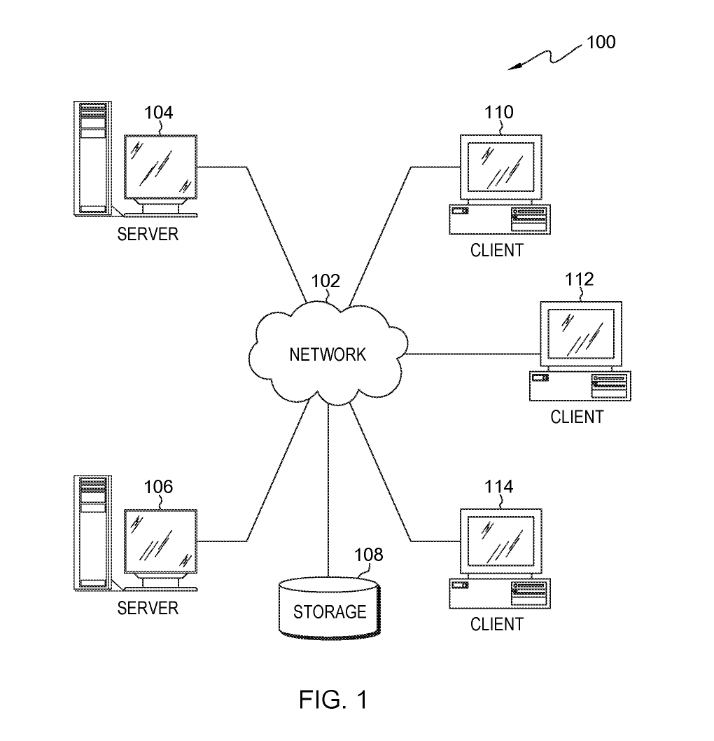

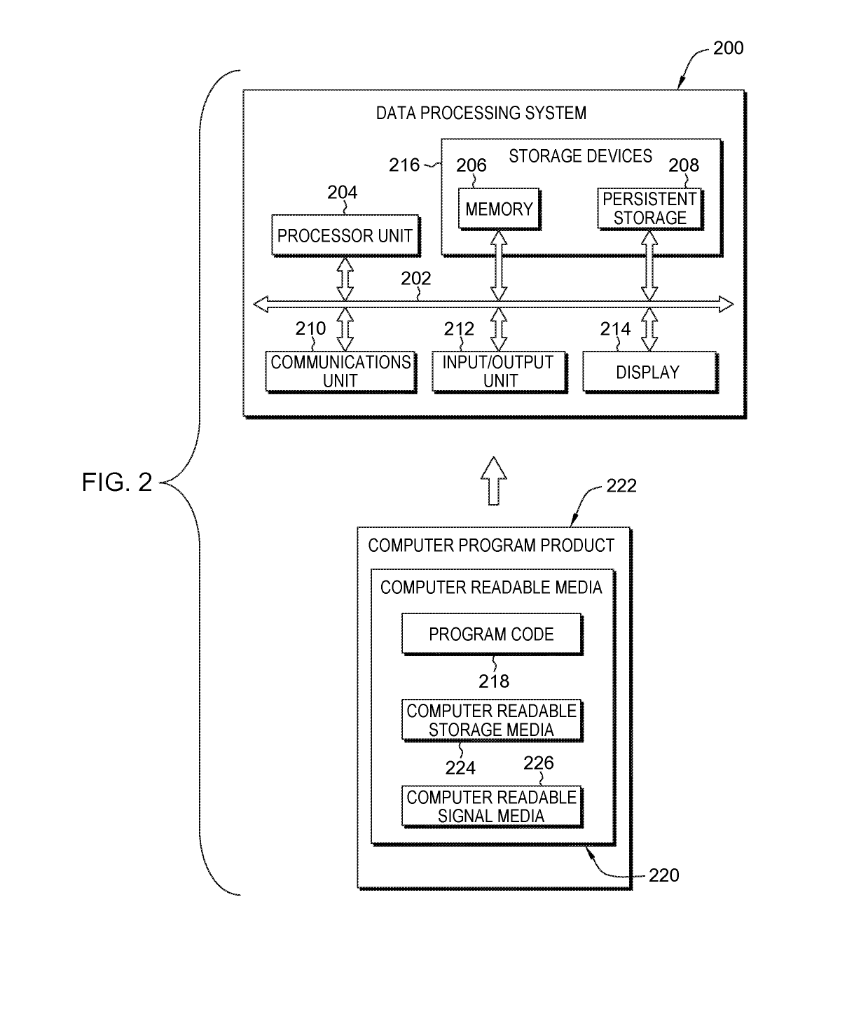

With reference now to the figures, and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communication links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides information, such as boot files, operating system images, and applications to clients 110, 112, and 114. Clients 110, 112, and 114 are clients to server 104 in this example. Network data processing system 100 may include additional servers, clients, and other devices not shown.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 depicts a diagram of a data processing system in accordance with an illustrative embodiment. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory, or any other suitable volatile or non-volatile storage device. Persistent storage 208 may take various forms, depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Communications unit 210, in these examples, provides for communication with other data processing systems or devices. In these examples, communications unit 210 is a network interface card. Communications unit 210 may provide communications through the use of either or both physical and wireless communications links.

Input/output unit 212 allows for the input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code, in the different embodiments, may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222. In one example, computer readable media 220 may be computer readable storage media 224 or computer readable signal media 226. Computer readable storage media 224 may include, for example, an optical or magnetic disc that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory that is connected to data processing system 200. In some instances, computer readable storage media 224 may not be removable from data processing system 200.

Alternatively, program code 218 may be transferred to data processing system 200 using computer readable signal media 226. Computer readable signal media 226 may be, for example, a propagated data signal containing program code 218. For example, computer readable signal media 226 may be an electro-magnetic signal, an optical signal, and/or any other suitable type of signal. These signals may be transmitted over communications links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system through computer readable signal media 226 for use within data processing system 200. For instance, program code stored in a computer readable storage media in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Embodiments of the invention provide a method, computer system, and computer program product for detecting an emerging life event and identifying an action plan to remediate affects of the life event.

Embodiments of the invention detect people's emerging life events by studying their temporal behaviors of, for instance, payment, engagement, etc., so that an underlying cause can be determined and an action can be proposed to remediate consequences of the event. Embodiments of the invention focus on the collections across insurance, credit card, and mortgage.

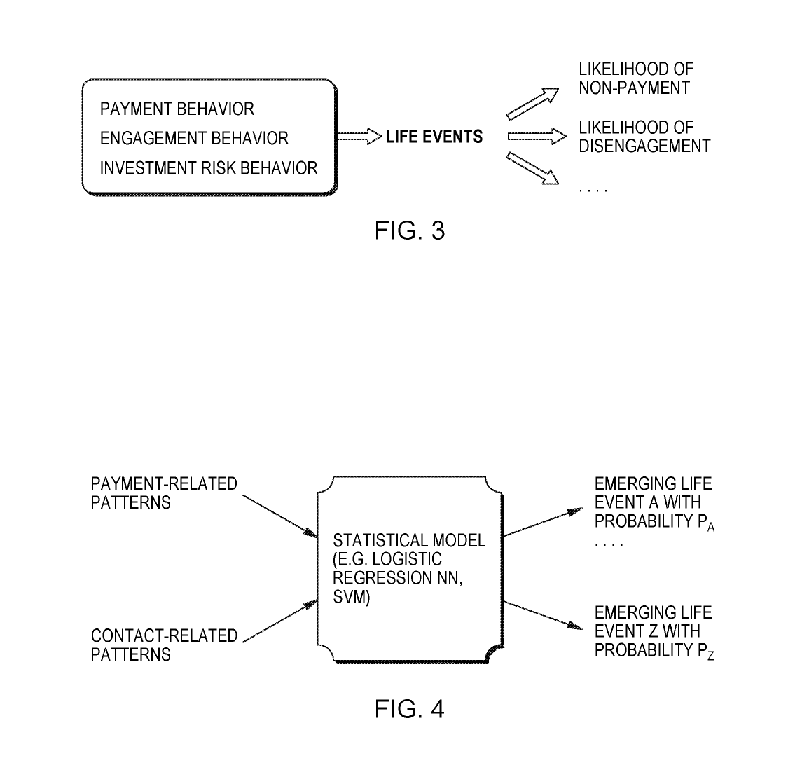

With reference to FIG. 3, embodiments of the invention detect emerging life events. Emerging life events are defined as events happen to customers and continue to show certain behavioral patterns over a sustained period of time. Because emerging events take effect over a period of time, there exists the opportunity for timely detection of these events, which can be coupled with proactive actions to manage the impact or consequences of the event. For example, a job loss and efforts to get another job may lead to certain payment and contact related behavior over time until the situation is corrected.

The pattern of behavior can be mined, for example, from payment behavior, engagement behavior, or investment risk behavior. Emerging life events can then be detected based on such behavior. After the life event is detected, an estimate or a future prediction can be made of, for instance, the likelihood of non-payment, or the likelihood of disengagement continuing.

With reference to FIG. 4, the patterns that can be observed are used to train a statistical model to detect the underlying (emerging) life events with a certain confidence. In this training, the model inputs may include payment-related patterns and contact-related patterns. The statistical model may use Logistic Regression, Neural Networks (NN), Support Vector Machine (SVM), and the model output is a series of life events A, . . . Z, each with an associated confidence or Probability, P_{A}, . . . P_{Z}.

Once the model is trained, the model can be used to predict life events that may have occurred or are occurring to a person. Appropriate actions can then be taken based on outcomes observed during/after past instances of the event.

As a specific example, embodiments of the invention may be used in the field of mortgage servicing. Data inputs may be from payment patterns, contract patterns (outgoing calls), method of engagement (incoming calls/web chat/U.S. mail). A change in behavior as observed in changes in these patterns signals likely events. Declared events in call logs may be used for training implicit detection models.

Embodiments of the invention target emerging life events with demonstrated impact on future likelihood of payment. Event types dictate appropriate action. For instance, for a short-term life event, some timely help may be offered to get loan payments back to current. For a long term life event, solutions may be sought such as mortgage modification.

Use of the invention may be expanded into, for example, financial services, banking/wealth management, and direct marketing. In financial services, embodiments of the invention may be used to recommend appropriate products based on emerging life events. In the field of banking/wealth management, embodiments of the invention may be used to infer emerging events such as approaching high school graduation from fine-grained transaction data, and translate that data into a tailored financial plan suitable for a family to support college education and recommend related product offerings. In direct marketing, embodiments of the invention may be used to determine the likelihood and best method of engagement with a customer.

As an example, embodiments of the invention may be used to detect life events of a person who has borrowed money. The events may be detected based on Defaulting Behavior, or unreachability characteristics.

For instance, financial hardship phrases in a customer interaction (typically a phone call) with the mortgage servicer usually include unemployment, excessive obligations, business failure, curtailment/loss of income. Personal hardship phrases usually include divorce, disability, marital difficulties, military service, incarceration, death, illness. Consequently, Foreclosure (FC) and Serious Foreclosure (SFC) customer accounts are more likely than average to mention Personal Hardship (and no-contact is worse than intermittent contact, which is worse than frequent contact), and Current (CUR) and Pre-Foreclosure (PFC) customer accounts are more likely than average to mention Financial Hardship.

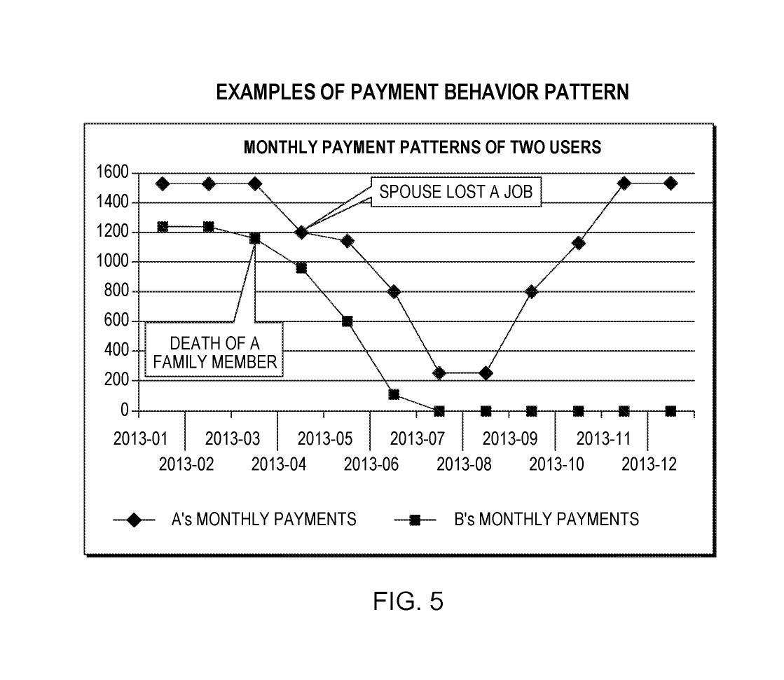

FIG. 5 shows examples of payment behavior patterns. In the case of person A, his or her spouse lost a job, and the payment pattern showed recovery after the spouse found a new job. In detecting this job-loss event, the loan service provider can potentially offer some temporary payment plan to the family. In the case of person B, after the death of a family member, the payment never recovered. In detecting this event, the loan service provider can potentially offer options, such as property liquidation, to the family, such as a short sale or a mortgage release.

Examples of specific life events whose effect lasts over time that may be related to embodiments of the invention are: Death/Illness of borrower; Death/Illness of borrower's family member; Marital difficulties; Curtailment of income; Distant employment transfer; Military service; Unemployment; business failure; Casualty loss; incarceration; Job Change; College; Relocation: Graduation/Child's Graduation.

Event definitions can be less specific, i.e., any recognizable pattern of behavior that correlates historically with a change in payment/contact outcomes. Some alternate, pattern based, event definitions would be: Late payment pattern, variable payment pattern, unwilling to contact, engaged with electronic channels, etc.

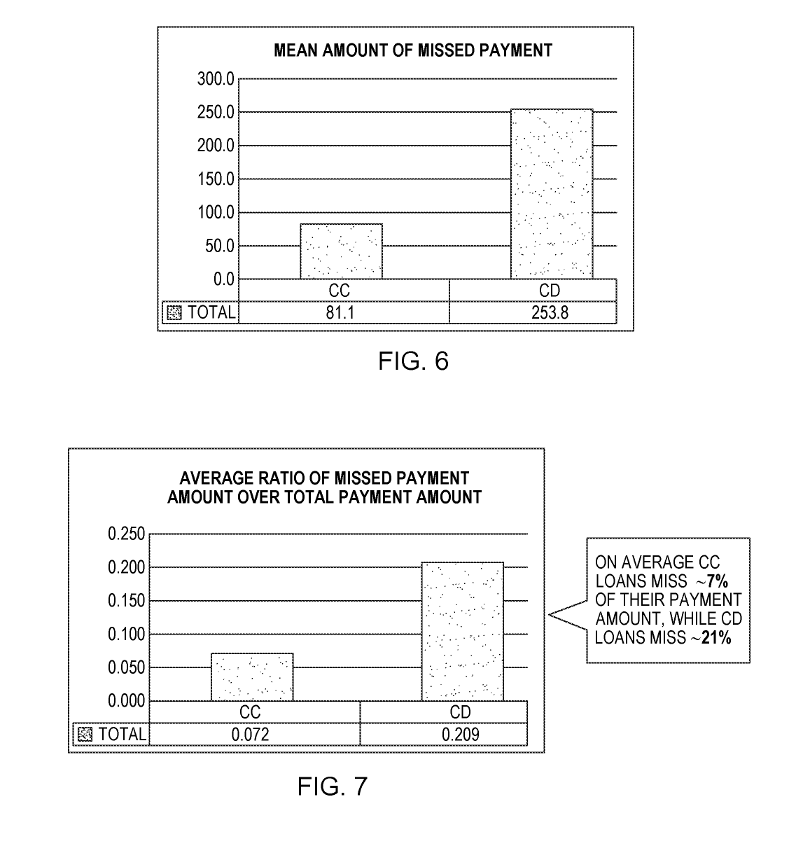

FIGS. 6-12 show Payment-related features that may be used in embodiments of the invention.

In one embodiment, a set of loan-payment-related behavioral features are developed, along with other loan-related features (such as credit scores, unpaid balances (UPB), loan-to-value (LTV), interest rates), to train a statistical model for payment pattern predictions.

These payment-related features are extracted from several continuous months (e.g., six months) of historical payment data for each particular loan.

With reference to FIG. 6, one feature is the average amount of missed payments, aggregated on a monthly basis (mean of mixed/partial payment).

The calculations for this feature are:
1. For each month M, measure
   Diff=Total payment of month M−the amount paid for month M
   If (Diff<=0), Missed_payment_for_M=0
   Else Missed_payment_for_M=Diff
2. The average amount of missed payment (MP) is measured over N-month period as
   MP=Sum of (Missed_payment_for_M) over the total number of required payments for N months

Another feature, illustrated in FIG. 7, is the average ratio of missed payment amount to the total payment amount.

Due to the fact that loans likely have different total payment amounts, the Missed_payment-for_M is normalized by Total_payment_for_M, and then this ratio is summed over N months and normalized by the total number of required payments.

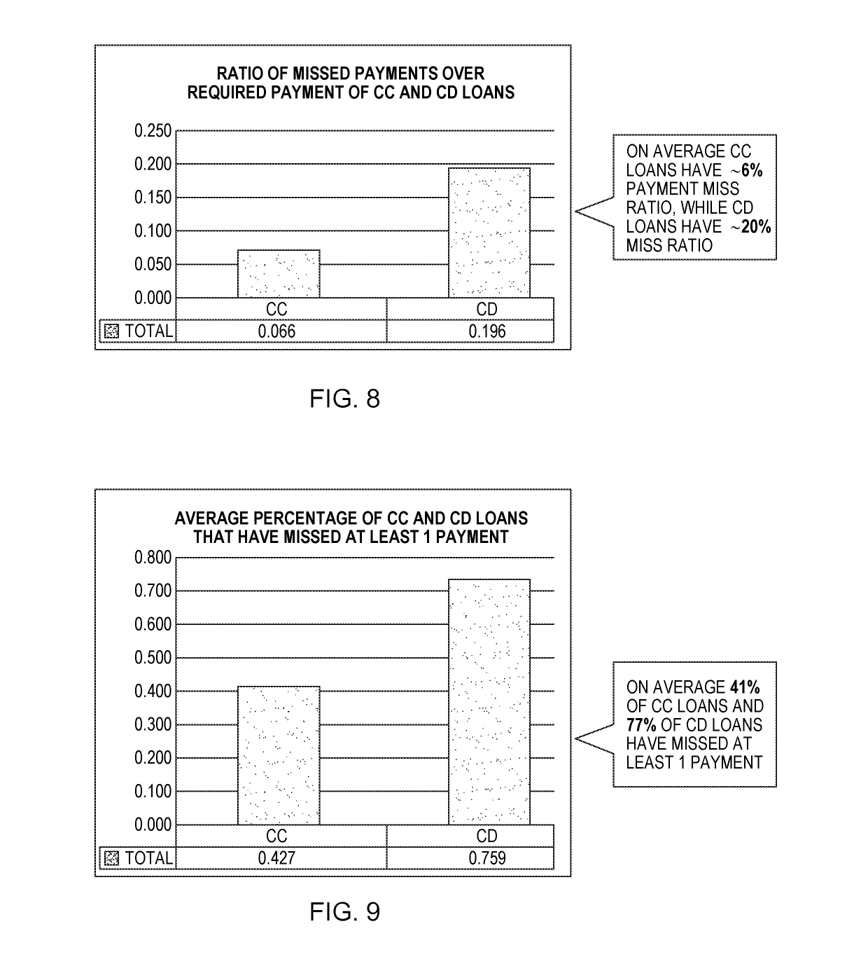

A third feature, shown in the chart of FIG. 8, is the ratio of the number of missed payments to the number of required payments. FIG. 8 shows this ration, referred to as the ratio of missed checks/total checks, for two different groups of loans. One group of loans, referred to as Current-Current (CC) loans, are loans that are current both at the beginning and the ending of a specific month. The second group of loans, referred to as Current-Default (CD) loans, are loans which are current at the beginning of a month, yet defaulting at the end of the month.

For this feature, missed payment means that the borrower completely missed the payment for a particular month. A partial payment is not considered as a missed payment.

Example of this calculation: Over the N-month period, measure the ratio of the total number of missed payment to the total number of required payments−the number of required payments could be less than N for new loans. The Fig. shows that on average, CC loans only have about 5% payment miss ratio, while CD loans could have up to 20% miss rate.

Another feature is to set a flag indicating whether a loan has missed a payment over a period of time or is on time (based on CC). For example, if a loan has not missed a payment over the N-month period, the flag can be set to TRUE; otherwise, the flag is FALSE.

FIG. 9 shows, as one example, average percentages of CC and CD loans that have missed at least one payment. As shown in FIG. 9, on average, 41% of CC loans and 77% of CD loans have missed at least one payment.

A fifth feature is an average payment delay (in days), which is measured as the mean of N-month payment delayment.

This feature observes how each loan delayed its payment in each month.

The calculations for this feature are:
1. For each month M, measure
   Diff=effective date of month M−Loan's Last Payment data
   if (DIFF<31 or 30), Payment_delay_for_M=0
   else Payment_delay_for_M=Diff.
2. The average payment delay (PD) is measured over the N-month period as
   PD=Sum of (Payment_delay_for_M) over the total number of required payments over the N-month period.

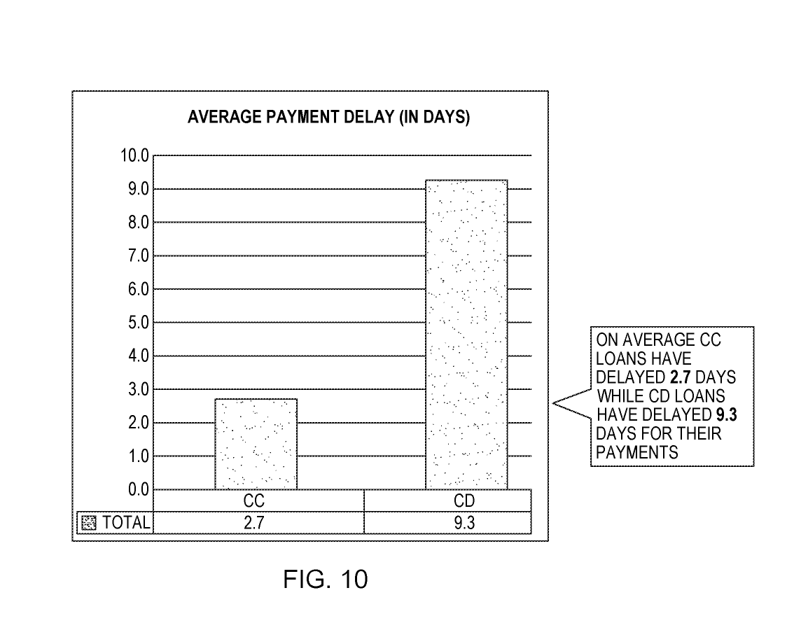

FIG. 10 shows example of Average Payment Delay (in days) for CC and CD loans. On average, CC loans have an average payment delay of 2.7 days, while CD loans have an average payment delay of 9.3 days.

A sixth feature is coefficient of variation of payment delay (Coefficient of variation).

The coefficient of Variation indicates the extent of variability in relation to the mean of a population, and is defined as the ratio of the standard deviation to the mean.

The coefficient of variation (CV) is defined as the ratio of the standard deviation σ to the mean μ:

$${c}_{v} = \frac{σ}{μ}$$

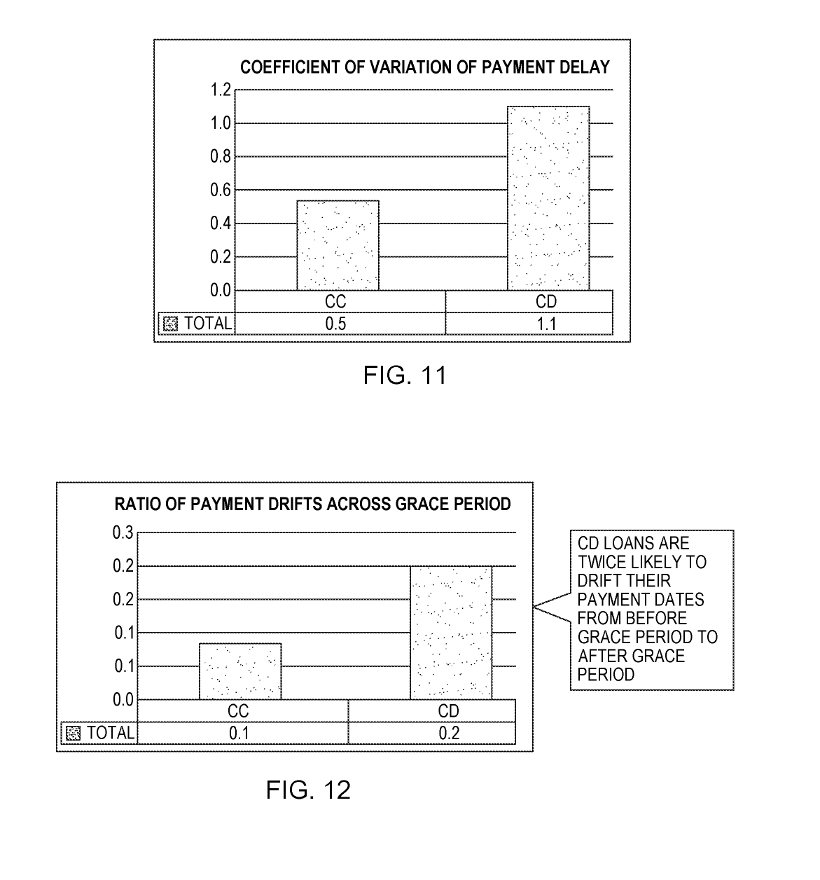

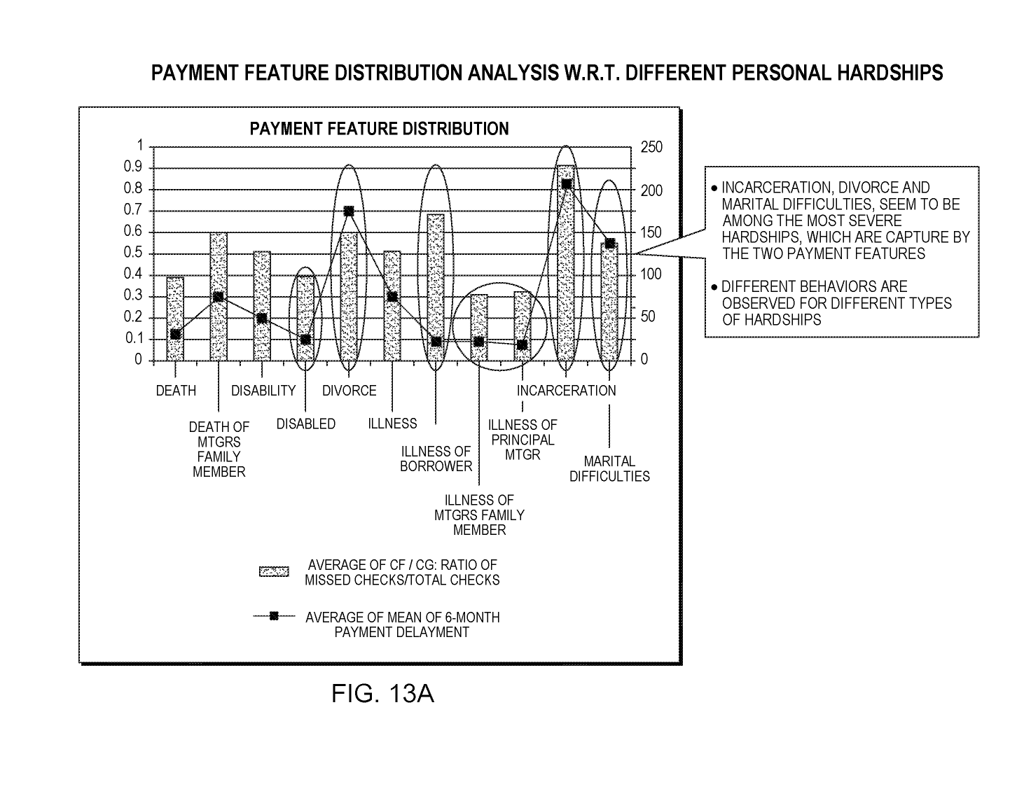

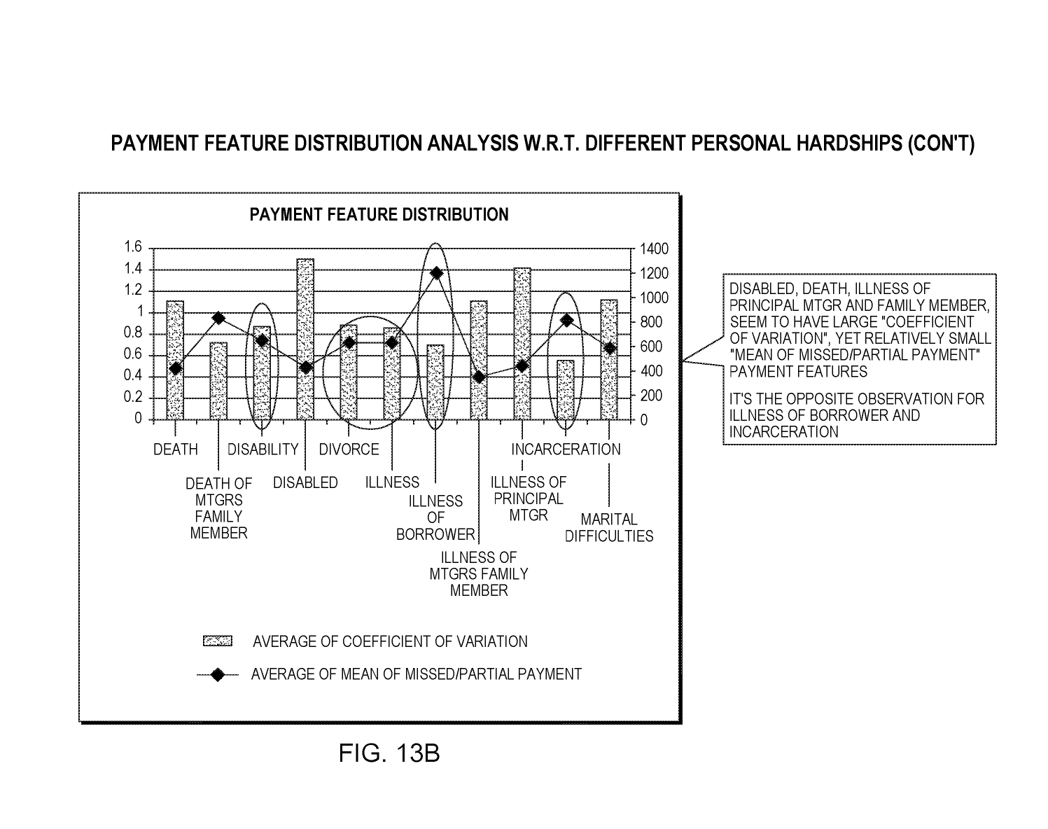

FIG. 11 shows the coefficient of variation of payment delay for a group of CC loans and a group of CD loans. With the example shown in FIG. 13, the coefficient of variation of payment delay for the CD loans is 0.5, and the variation of payment delay for the CD loans is 1.1.

An additional feature is the ratio of payment drifts across a grace period (referred to as the ratio of payment drifting times). A grace period is usually defined as the middle of a month.

This feature indicates how many times a loan payment drifts from before the grace period to after the grace period over an N-month period. This number may be normalized by the total number of required payments over that N-month period.

FIG. 12 is a chart showing ratios of payment drift across a grace period for a group of CC loans and a group of CD loans. In this example, the CD loans are twice as likely as the CC loans to have their payment dates drift from before the grace period to after their grace periods.

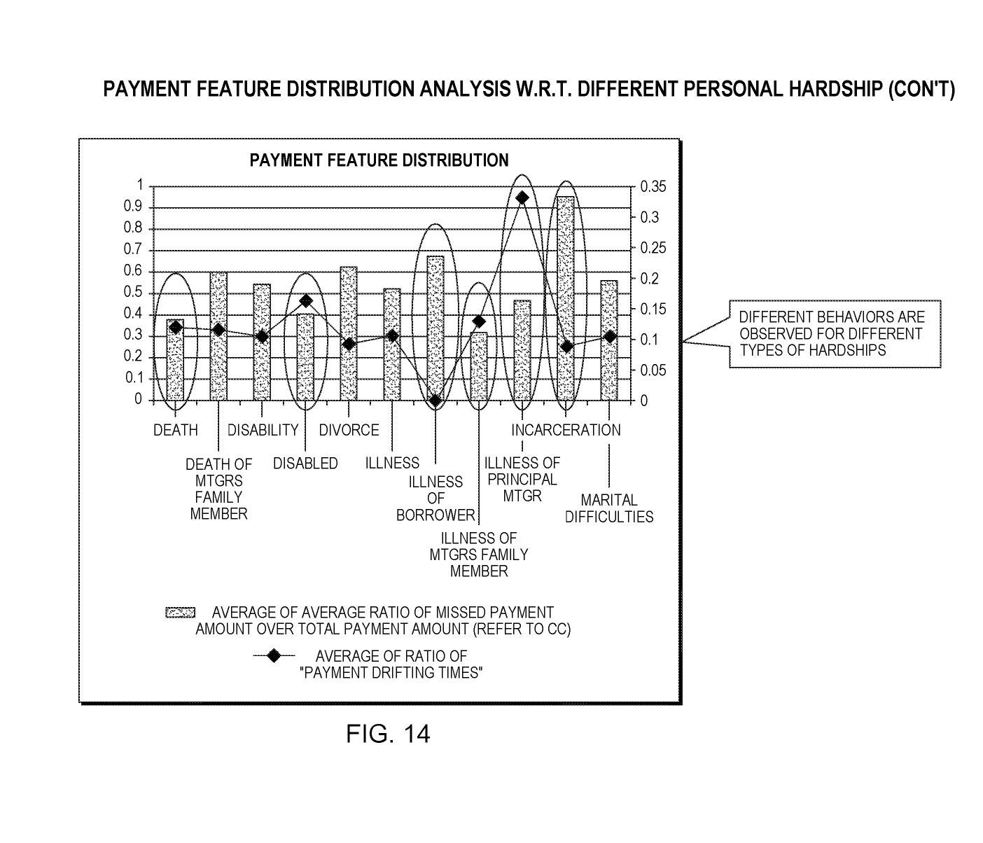

FIGS. 13 and 14 illustrate payment feature distribution analysis with respect to different personal hardships.

The upper left chart in FIG. 13 shows for each of a number of life events, the average ratio of missed payments to total payments made, and the average of the mean of six month payment delays. As the chart shows, incarceration, divorce and marital difficulties have large values of both features, and consequently they are among the most severe hardships. Other hardships such as illness of borrower, have a large value of one feature yet a small value of the other. This shows that different types of hardships have different payment behaviors.

The lower right chart in FIG. 15 shows, for each of the same life events listed in the upper left chart, the average of coefficient of variation, and the average of mean of missed or partial payments. Events of disability, death, illness of principal mortgagor, and illness of mortgagor's family member appear to have large “coefficient of variation,” yet relatively small “mean of missed/partial payment” payment features. In contrast, the opposite observation can be made for illness of borrower and incarceration.

FIG. 14 shows, for each of the life events listed in the charts of FIG. 15, the average of the average ratio of missed payment amount to total payment amount, and the average of the above-discussed payment drifting times. Again, different types of hardships have presented very different behaviors.

The above-discussion shows that the proposed payment features can effectively differentiate among the payment patterns of different borrowers who are experiencing different types of personal hardships.

Embodiments of the invention exploit the payment patterns to detect emerging life events and consequently, apply the right actions.

With embodiments of the invention, different payment patterns are extracted over an extended time period, and the relationships between payment patterns and customer life events are learned using labeled data to provide a model. Once the training is done, the model relates payment pattern differences to their underlying life events. When a new customer's payment pattern changes, the model can be applied to the customer data to determine his/her most likely emerging life events. Once the underlying life event is determined, appropriate actions to address the situation can be implemented.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

1. A method of detecting an emerging life event and identifying an action plan to remediate affects of the life event, the method comprising:
specifying a group of defined emerging life events, and a group of defined behavior features that map to the defined emerging life events;
receiving, by a data processing system, behavioral data identifying behavior of a person;
analyzing the behavioral data, by the data processing system, to determine if any of the specified group of defined behavior features are identified in the behavioral data as behavior features of said person;
when one or more of the specified group of defined behavior feature are identified in the behavioral data as behavior features of said person, mapping said one or more of the identified behavior features, by the data processing system, to one or more of the specified group of defined emerging life events; and
using the mapped one or more defined emerging life events to determine an action plan to remediate affects of the mapped one or more life events on a specified activity of the person.

2. The method according to claim 1, wherein:
the specifying a group of defined emerging life events, and a group of defined behavior features that map to the defined emerging life events includes
inputting into the data processing system historical time-series of behavioral data of a group of people, the behavioral data including a multitude of behavior features and a multitude of life events associated with the multitude of behavior features, and
building a model, by the data processing system, to learn associations between the multitude of behavior features and the multitude of life events; and
the mapping said one or more of the identified behavior features, by the data processing system, to one or more of the specified group of defined emerging life events includes using the model to map said one or more of the identified behavior features, by the data processing system, to one or more of the specified group of defined emerging life events

3. The method according to claim 2, wherein the specified group of behavior features are extracts of financial payments.

4. The method according to claim 3, wherein the extracts of financial payments include one or more of the following: mean amount of missed payment, average ratio of missed payment amount over total payment amount, ratio of missed payments over required payment, payment miss flag, average duration of payment delay, coefficient of variation of payment delay, and ratio of payment drifts across grace period.

5. The method according to claim 2, wherein the using the mapped one or more of the emerging life events to determine an action plan includes constructing a personalized model for predicting future behavior of the person based on a profile of the person and a selected one or more of the emerging life events.

6. The method according to claim 5, wherein the using the mapped one or more of the emerging life events to determine an action plan further includes determining actions to achieve a desired outcome from the predicted future behavior.

7. The method according to claim 6, wherein the action plan mitigates consequences of the predicted future behavior of the person.

8. The method according to claim 1, wherein the action plan is an action plan for the person.

9. The method according to claim 1, wherein the action plan is an action plan for an entity or an individual other than the person.

10. The method according to claim 9, wherein the action plan mitigates consequences of predicted future behavior of the person on said entity or individual.

11. A computer system for detecting an emerging life event and identifying an action plan to remediate affects of the life event, the computer system comprising:
a storage device storing program code: and
one or more processor units connected to the storage device for executing the program code to:
receive input specifying a group of defined emerging life events, and a group of defined behavior features that map to the group of defined emerging life events;
receive behavioral data input identifying behavior of a person;
analyze the behavioral data to determine if any of the specified group of defined behavior features are identified in the behavioral data as behavioral features of said person;
when one or more of the specified group of behavior feature are identified in the behavioral data as behavior features of said person, map said one or more of the identified behavior features to one or more of the specified group of emerging life events; and
the executing the program code to analyze the behavioral data to determine if any of the specified group of defined behavior features are identified in the behavioral data as behavioral features of said person includes executing the program code to use the model to analyze the behavioral data to determine if any of the specified group of defined behavior features are identified in the behavioral data as behavioral features of said person.
use the mapped one or more emerging life events to determine an action plan to remediate affects of the mapped one or more emerging life events on a specified activity of the person.

12. The computer system according to claim 11, wherein:
the one or more processor units further executes the program code to:
receive as input historical time-series of behavioral data of a group of people, the behavioral data including a multitude of behavior features and a multitude of life events associated with the multitude of behavior features; and
build a model to learn associations between the multitude of behavior features and the multitude of life events; and
the executing the program code to map said one or more of the identified behavior features to one or more of the specified group of defined emerging life events includes executing the program code to use the model to map said one or more of the identified behavior feature to one or more of the specified group of defined emerging life events.

13. The computer system according to claim 12, wherein the specified group of behavior features are extracts of financial payments.

14. The computer system according to claim 12, wherein the executing the program code to use the mapped one or more emerging life events to determine an action plan to remediate affects of the mapped one or more emerging life events on a specified activity of the person includes executing the program code to construct a personalized model for predicting future behavior of the person based on a profile of the person and a selected one or more of the emerging life events.

15. The computer system according to claim 11, wherein the action plan mitigates consequences of predicted future behaviors of the person.

16. A computer program product comprising:
a computer readable storage medium having computer program code tangibly embodied therein for detecting an emerging life event and identifying an action plan to remediate affects of the life event, the computer program code, when executed in a computer system, performing the following:
specifying a group of defined emerging life events, and a group of defined behavior features that map to the defined emerging life events;
receiving behavioral data input identifying behavior of a person;
analyzing the behavioral data to determine if any of the specified group of defined behavior features are identified in the behavioral data as behavior features of said person;
when one or more of the specified group of defined behavior feature are identified in the behavioral data as behavior features of said person, mapping said one or more of the identified behavior features to one or more of the specified group of defined emerging life events; and
using the mapped one or more defined emerging life events to determine an action plan to remediate affects of the mapped one or more life events on a specified activity of the person.

17. The computer program product according to claim 16, wherein:
the specifying a group of defined emerging life events, and a group of defined behavior features that map to the defined emerging life events includes
receiving as input historical time-series of behavioral data of a group of people, the behavioral data including a multitude of life events and a multitude of associated behavior features, and
building a model to learn associations between the multitude of behavior features and the multitude of life events, and
the mapping said one or more of the identified behavior features to one or more of the specified group of defined emerging life events using the model for mapping said one or more of the identified behavior features to one or more of the specified group of defined emerging life events.

18. The computer program product according to claim 16, wherein the specified group of behavior features are extracts of specified financial payments.

19. The computer program product according to claim 16, wherein the using the mapped one or more of the emerging life events to determine an action plan includes constructing a personalized model for predicting future behavior of the person based on a profile of the person and a selected one or more of the emerging life events.

20. The computer program product according to claim 17, wherein the using the mapped one or more of the emerging life events to determine an action plan further includes determining actions to achieve a desired outcome from the predicted future behavior.
